(19) United States
(12) Patent Application Publication
(10) Pub. No.: US 2018/0169580 A1
(43) Pub. Date: Jun. 21, 2018

(54) METHOD AND SYSTEM FOR TEMPERATURE CONTROL IN CATALYTIC OXIDATION REACTIONS

(71) Applicant: Haldor Topsøe A/S, Kgs. Lyngby (DK)

(72) Inventors: Johannes Skotte, Farum (DK); Jørn Møller Rasmussen, Virum (DK)

(73) Assignee: Haldor Topsøe A/S, Kgs. Lyngby (DK)

(21) Appl. No.: 15/735,049

(22) PCT Filed: Jun. 30, 2016
(86) PCT No.: PCT/EP2016/065257

§ 371 Date: Dec. 8, 2017

(30) Foreign Application Priority Data
Jul. 3, 2015 (DK) PA 2015 00378

(51) Int. Cl. B01D 53/86; B01D 53/90; B01D 39/06; B01D 39/08; B01J 21/06; B01J 23/22; B01J 23/648

(52) U.S. Cl. CPC B01D 53/864; B01D 53/8696; B01D 53/90; B01D 39/06; B01D 39/08; B01J 21/063; B01D 2257/708; B01J 23/6482; B01D 2239/0492; B01D 2251/2062; B01D 2251/2067; B01D 2257/502; B01J 23/22

(57) ABSTRACT

A method and system for temperature control in catalytic oxidation of hazardous compounds to protect the catalytic system against thermal overload by means of injecting adsorbing ammonia reagent, in order to reduce the exothermic reaction from oxidation and the resulting temperature rise.

The present invention relates to a method and system for temperature control in catalytic oxidation of hazardous compounds to protect the catalytic system against thermal overload by means of injecting adsorbing ammonia reagent, in order to reduce the exothermic reaction from oxidation and the resulting temperature rise.

Carbon monoxide and volatile organic compounds (VOC) comprising hazardous air pollutants (HAPs) such as aromatic and polyaromatic hydrocarbons are typically contained in a number of industrial process-gases and flue-gas from the combustion of coal and oil and municipal waste incineration.

The above mentioned combustion off-gases and off-gases from industrial process such as the production of cement and glass and steel typically contain additionally particulate matter and nitrogen oxides.

For the sake of simplicity industrial process-gases and combustion flue-gas are in the following description and the claims defined as “off-gas” or “off-gases”.

A problem in the cleaning of off-gases by catalytic oxidation is widely varying amounts of oxidizable compounds and/or concentration peaks of these compounds in the off-gas.

Catalytic oxidation of oxidizable compounds like carbon monoxide and VOCs is an exothermal process, in which heat is released due to the oxidation reaction. The amount of released heat evidently depends on the concentrations of these compounds.

As an example oxidation of carbon monoxide to carbon dioxide contributes with approximately 9° C. per 1000 ppm in air. In the case of a sudden peak in CO concentration of e.g. 1 vol % the temperature will increase by approximately 94° C. in air, which can thermally deactivate the oxidation catalyst or the carrier substrate.

Frequently oxidation catalysts used in removal carbon monoxide and VOC from industrial off-gases are vanadium oxide and titania based catalysts optionally promoted with noble metal such as palladium. There is a risk of thermal decomposition of vanadium oxide and undesired sintering of titania at high temperatures caused by exothermal oxidation of excessive amounts of CO and VOC's in the off-gas.

Fabric filters are typically employed in the removal of particulate materials from flue gases emerging from industrial processes and combustion processes.

These filters are either produced with woven or non-woven fabric fibrous material providing a porous filtration media for capturing fine particulate matter. Furthermore, the filters can be upgraded to catalyzed fabric filters by impregnation with catalytic material for removal of gas components such as carbon monoxide, and VOC's and nitrogen oxides.

Catalyzed fabric filters in form of e.g. filter bags can be used in many industries for removal of particulate matter and CO and VOC from off-gases. The filters can be made from various woven, non-woven or felted materials or mixtures thereof comprising natural fibers, synthetic fibers, or other fibers such as glass fibers, ceramic or metallic fibers.

Due to the composition of the fibers constituting the filter and the filter membrane, these are typically operated at temperatures lower than 260° C., the usual temperature window of operation is 200 to 250° C.

Higher temperatures can result in an irreversible thermal damage of the fabric substrate material or the filter membrane.

We have observed that the temperature of a catalyzed substrate comprising an oxidation catalyst can be controlled by addition of ammonia into the off-gas upstream the catalyst, when employing an ammonia sensitive oxidation catalyst.

Pursuant to this observation the present invention is according to a first aspect a method for temperature control in catalytic oxidation of hazardous compounds comprising carbon monoxide and volatile organic compounds from off-gas comprising the steps of

a) providing a catalyzed substrate with an oxidation catalyst sensitive to ammonia adsorption;

b) continuously monitoring and measuring the content of the carbon monoxide and the volatile organic compounds at a position upstream of the catalyzed substrate and/or continuously monitoring and measuring temperature of the off-gas downstream of the catalyzed substrate;

c) oxidizing the carbon monoxide and the volatile organic compounds in the off-gas by contact with the catalyzed substrate of step a);

d) adding ammonia or urea into the off-gas at a position upstream of the catalyzed substrate, when the content of the carbon monoxide and/or the volatile organic compounds exceeds a predetermined threshold value or the temperature of the off-gas after contact with the catalyzed substrate has reached a predetermined threshold value, so that ammonia is adsorbed on the oxidation catalyst; and

e) interrupting the injection of ammonia or urea, when the content of the carbon monoxide and/or the volatile organic compounds is below the predetermined threshold value or the temperature of the catalyzed substrate in the off-gas after contact with the substrate is lower than the predetermined threshold value.

Preferred features of the invention are disclosed in the following description.

In the event that the concentration of CO and VOCs exceeds a predetermined value as measured by e.g. an FTIR analyzer arranged upstream of the catalyzed substrate, ammonia is injected into the off-gas at a point close to the inlet of the substrate at a concentration exceeding the ammonia to nitrogen oxide molar ratio (ammonia NOx ratio, ANR) of 1 (ANR>1).

Amounts of ammonia sufficiently suppress the oxidation activity of for instance CO, at concentrations from 1 ppmv to 5 vol % (at ANR>1).

Off-gases very often contain nitrogen oxides (NOx), in addition to carbon monoxide and VOC, in concentrations that have to be reduced depending on local legislation.

The abatement of NOx with an oxidation catalyst further having activity in selective catalytic reduction (SCR) in presence of ammonia.

When the off-gas also contains NOx ammonia must be added into the off-gas in gas of excessive amounts of CO and VOCs in an amount resulting in an ammonia to NOx molar ratio (ANR) of higher than 1.

The catalyzed substrate can be in any of the known catalyst shapes, including a monolithic shape.

As already mentioned above, process off-gases contain usually particulate matter, which can be effectively retained when forming the catalyzed substrate as a filter.

Preferably the catalyzed substrate for use in the invention comprises woven or non-woven fibers, in particular ceramic fibers, glass fibers and/or biodegradable and/or biosoluble fibers.

The substrate can be coated with polymeric material.

Preferred oxidation catalysts for use in the invention are selected from the group of palladium, platinum, oxides of vanadium, molybdenum, tungsten, yttrium, lanthanum, titanium, aluminum and mixtures thereof.

In particular, vanadium oxide-based catalysts supported on titania or alumina are commonly used catalysts for NOx reduction by selective reduction of NOx with NH3 in stationary and automotive applications. Efficient oxidation catalysts are palladium or platinum in their oxide and/or metallic form. These metals and metal compounds have good ammonia adsorption property and their oxidation activity can be sufficiently suppressed by addition to excessive amounts of ammonia added to the off-gas.

Preferred oxidation catalysts for use in the invention comprise oxides of vanadium and titanium or palladium and/or platinum and oxides of vanadium and titanium. These catalysts are active both in the removal of VOCs and carbon monoxide and in the removal of NOx if present in the off-gas by the SCR reaction with NH₃.

After having interrupted the addition of ammonia or urea into the off-gas, the oxidation catalyst is preferably regenerated by reducing the ammonia concentration added to the gas to a level of ANR<1.

When the off-gas already contains nitrogen oxides, the ammonia reductant for the SCR reaction is added in an amount providing a molar ratio of ammonia to NOx of less than 1 for the regeneration of the catalyst.

A further aspect the invention provides a system for temperature control in catalytic oxidation of hazardous compounds of hazardous compounds comprising carbon monoxide and volatile organic material from off-gas comprising

a catalyzed substrate with an oxidation catalyst sensitive to ammonia adsorption;
means for continuously monitoring or measuring the content of carbon, the carbon monoxide and the volatile organic material in the off-gas, the means is arranged upstream of the catalyzed substrate and/or means for continuously measuring the temperature in the off-has downstream to the catalyzed substrate; and
means for adding ammonia or urea into the off-gas arranged at a position upstream of the catalyzed substrate;
means for interrupting the addition of ammonia arranged at a position upstream of the catalyzed substrate, wherein the means for adding ammonia is configured to be active for injection of ammonia when the content of the carbon monoxide and/or volatile organic compounds is above a predetermined threshold value as measured by the means for continuously monitoring and measuring the content of the carbon monoxide and the volatile organic compounds and/or the temperature in the off-gas is above a predetermined threshold value as measured by the means for continuously measuring the temperature in the off-gas; and wherein the means for interrupting the addition of ammonia is configured to be active when the content of the carbon monoxide and/or volatile organic compounds is below a predetermined threshold value as measured by the means for continuously monitoring and/or the temperature is below a predetermined threshold value as measured by the means for continuously measuring the temperature in the off-gas.

In one embodiment the catalyzed substrate is in form of a filter.

The catalyzed substrate can also be in form of a flow through monolith.

In still an embodiment the catalyzed substrate comprises woven or non-woven fibers.

In a further embodiment the fibers comprise glass fibers.

In another embodiment the fibers comprise biodegradable and/or biosoluble fibers.

In still an embodiment the fibers are coated with a polymeric material.

In a further embodiment the oxidation catalyst is selected from the group of palladium, platinum, oxides of vanadium, molybdenum, tungsten, yttrium, lanthanum, titanium, aluminum and mixtures thereof.

In another embodiment the oxidation catalyst comprises palladium and/or platinum and oxides of vanadium and titanium.

In an embodiment the system comprises means for addition of nitrogen oxides to the off-gas arranged upstream of the catalyzed substrate.

The invention is further illustrated in the following description.

In operation of a specific embodiment of the invention catalytic filter bags are arranged in a cement plant downstream the SNCR (selective non-catalytic reaction), in which ammonia is injected upstream. The catalyzed filter bags can resist up to 260° C. before thermal degradation.

In this example both ammonia and NOx will be present in the gas together with VOC.

Various VOC or HAPs (Hazardous Air Pollutants) can be present in the flue gas besides ammonia and NOx (where ammonia to NOx molar ratio (ANR)<1), like toluene, formaldehyde, carbon monoxide and xylenes.

In the case of an upset condition, the VOC concentration suddenly increases from e.g. 100 ppmv to 1 vol % CO (detected by an upstream FTIR or the like). When the VOCs reach the catalyst, irreversible thermal damage from the exothermic oxidation (dT from 1 vol % CO is ˜94° C. in air) will destroy the catalyst and/or the polymeric membrane.

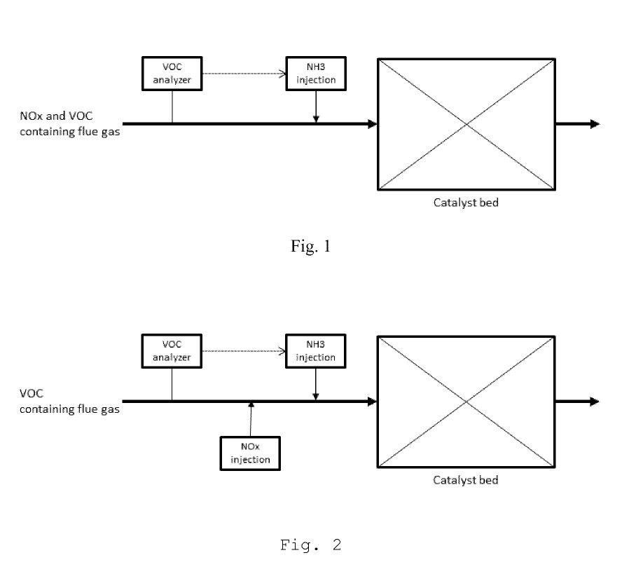

To prevent this, an VOC analyzer triggers an excess ammonia (ANR>1) dosage, either from the SNCR NH3-dosage unit or from an additional NH3 injection point located closer to the catalyst (cf. FIG. 1).

The excess amount of ammonia (in relation to the NOx concentration) can be (but is not limited to) in the range of 1-50,000 ppmv.

The preventive action will result in ammonia adsorption on the active sites of a Pd/V/Ti catalyst, and thus cease the exothermal CO oxidation reaction.

Once the VOC concentration entering the catalyst has settled to normal or lower levels, where the exothermic oxidation reaction will not damage the catalyst, the excess ammonia dosage is reduced again to ANR<1 or completely interrupted. The excess NOx will then react with the absorbed NH3 on the catalyst via the normal SCR reaction, and thus “regenerate” the catalyst back to an active state.

In another specific embodiment a V/Ti or Pd/V/Ti type catalyst is contacted with an off-gas neither containing NOx nor ammonia.

In this embodiment an ammonia injection system serves as a protection system for the catalyst. In addition, a NOx addition system will be required in order to “regenerate” the ammonia-adsorbed catalyst again, as outlined in FIG. 2.

1. A method for temperature control in catalytic oxidation of hazardous compounds comprising carbon monoxide and volatile organic compounds from off-gas comprising the steps of
a) providing a catalyzed substrate with an oxidation catalyst sensitive to ammonia adsorption;
b) continuously monitoring and measuring the content of the carbon monoxide and the volatile organic compounds at a position upstream of the catalyzed substrate and/or continuously monitoring and measuring temperature of the off-gas downstream of the catalyzed substrate;
c) oxidizing the carbon monoxide and the volatile organic compounds in the off-gas by contact with the catalyzed substrate of step a);
d) adding ammonia or urea into the off-gas at a position upstream of the catalyzed substrate, when the content of the carbon monoxide and/or the volatile organic compounds exceeds a predetermined threshold value or the temperature of the off-gas after contact with the catalyzed substrate has reached a predetermined threshold value, so that ammonia is adsorbed on the oxidation catalyst; and
e) interrupting the injection of ammonia or urea, when the content of the carbon monoxide and/or the volatile organic compounds is below the predetermined threshold value or the temperature of the catalyzed substrate in the off-gas after contact with the substrate is lower than the predetermined threshold value.

2. The method of claim 1, wherein the off-gas further comprises nitrogen oxides.

3. The method of claim 1, wherein the off-gas further comprises particulate matter.

4. The method of claim 1, wherein the catalyzed substrate of step a) is in form of a filter.

5. The method of claim 1, wherein the catalyzed substrate comprises woven or non-woven textile, ceramic or glass fibers.

6. The method claim 5, wherein the fibers are coated with a polymeric material.

7. The method according to claim 1, wherein the oxidation catalyst comprises at least one of palladium, platinum, and oxides of vanadium, molybdenum, tungsten, yttrium, lanthanum, titanium and aluminum.

8. The method of claim 7, wherein the oxidation catalyst comprises vanadium oxide and titanium oxide or palladium, vanadium oxide and titanium oxide.

9. The method according to claim 1, wherein nitrogen oxides are added to the off-gas subsequent to the interruption of ammonia or urea addition in step e).

10. The method according to claim 2, wherein ammonia or urea is added to the off-gas in an amount to provide an ammonia to nitrogen oxides ratio of less than 1 for a period of time, subsequent to the interruption of ammonia or urea addition in step e).

11. The method of claim 1, comprising the further step of regenerating the oxidation catalyst having adsorbed ammonia in step d) by adding nitrogen oxides into the off-gas subsequent to step e) in an amount to provide an ammonia to nitrogen oxides molar ratio of less than 1.

12. A system for temperature control in catalytic oxidation of hazardous compounds of hazardous compounds comprising carbon monoxide and volatile organic material from off-gas comprising
a catalyzed substrate with an oxidation catalyst sensitive to ammonia adsorption;
means for continuously monitoring or measuring the content of carbon the carbon monoxide and the volatile organic material in the off-gas, the means is arranged upstream of the catalyzed substrate and/or means for continuously measuring the temperature in the off-has downstream to the catalyzed substrate; and
means for adding ammonia or urea into the off-gas arranged at a position upstream of the catalyzed substrate;
means for interrupting the addition of ammonia arranged at a position upstream of the catalyzed substrate, wherein the means for adding ammonia is configured to be active for injection of ammonia when the content of the carbon monoxide and/or volatile organic compounds is above a predetermined threshold value as measured by the means for continuously monitoring and measuring the content of the carbon monoxide and the volatile organic compounds and/or the temperature in the off-gas is above a predetermined threshold value as measured by the means for continuously measuring the temperature in the off-gas; and wherein the means for interrupting the addition of ammonia is configured to be active when the content of the carbon monoxide and/or volatile organic compounds is below a predetermined threshold value as measured by the means for continuously monitoring and/or the temperature is below a predetermined threshold value as measured by the means for continuously measuring the temperature in the off-gas.

13. The system of claim 12, wherein the catalyzed substrate is in form of a filter.

14. The system of claim 12, wherein the catalyzed substrate comprises woven or non-woven textile ceramic or glass fibers.

15. The system according to claim 14, wherein the fibers are coated with a polymeric material.

16. The system according to claim 13, wherein the oxidation catalyst is selected from the group of palladium, platinum, oxides of vanadium, molybdenum, tungsten, yttrium, lanthanum, titanium, aluminum and mixtures thereof.

17. The system of claim 16, wherein the oxidation catalyst comprises oxides of vanadium and titanium or palladium and oxides of vanadium and titanium.

18. The system according to claim 12, further comprising means for addition of nitrogen oxides to the off-gas arranged upstream of the catalyzed substrate.
